(19) United States
(12) Patent Application Publication
(10) Pub. No.: US 2014/0081708 A1
(43) Pub. Date: Mar. 20, 2014

(54) LATENT SEMANTIC ENGINEERING PROCESSES, DEVICES, AND METHODS

(71) Applicant: NATIONAL TAIWAN UNIVERSITY, TAIPEI (TW)

(72) Inventors: SHANA SMITH, TAIPEI (TW); GREGORY C. SMITH, NEW TAIPEI CITY (TW)

(73) Assignee: NATIONAL TAIWAN UNIVERSITY, TAIPEI (TW)

(21) Appl. No.: 13/845,764

(22) Filed: Mar. 18, 2013

(30) Foreign Application Priority Data
Sep. 20, 2012 (TW) 101134574

(51) Int. Cl. G06Q 30/02

(52) U.S. Cl. CPC G06Q 30/0203
USPC 705/7.32

(57) ABSTRACT

Latent Semantic Engineering processes, devices, and methods match (aspirational, emotional, functional, physical) Latent Semantic Engineering semantic space user needs to (aspirational, emotional, functional, physical) Latent Semantic Engineering semantic space designs. Latent Semantic Engineering processes, devices, and methods thereby match user needs to designs, increase matching accuracy, and increase product quality, customer satisfaction, and product success.

### FIELD

The present invention relates to Latent Semantic Engineering processes, devices, and methods. Moreover, the present invention relates to Latent Semantic Engineering processes, devices, and methods that match (aspirational, emotional, functional, physical) Latent Semantic Engineering semantic space user needs to (aspirational, emotional, functional, physical) Latent Semantic Engineering semantic space designs. Moreover, the present invention relates to Latent Semantic Engineering processes, devices, and methods that thereby match user needs to designs, increase matching accuracy, and increase product quality, customer satisfaction, and product success.

### BACKGROUND

### Design Processes, Devices, and Methods

Design processes, devices, and methods play a vital role in the product design process.

Reverse Kansei Engineering (KE-QT1) processes, devices, and methods match (emotional) user needs to (emotional, functional) designs.

KE-QT1 processes, devices, and methods use (emotional) user need surveys to transform (emotional) user concepts into (emotional) user needs, use (emotional) sample design surveys, (functional) sample designs, and (emotional, functional) regression analysis to transform (functional) sample designs into (emotional, functional) KE-QT1 regression models, use (emotional, functional) KE-QT1 regression models to transform (functional) designs into (emotional, functional) designs, and use (emotional) correlations to match (emotional) user needs to (emotional, functional) designs.

Kansei Engineering (KE) methods transform (functional) sample designs into (emotional, functional) designs.

KE processes, devices, and methods use (emotional) sample design surveys, (functional) sample designs, and (emotional, functional) regression analysis to transform (functional) sample designs into (emotional, functional) designs.

Conjoint Analysis (CA) processes, devices, and methods transform (functional) sample designs into (functional) designs.

CA processes, devices, and methods use (functional) sample design surveys, (functional) sample designs, and (functional) regression analysis to transform (functional) sample designs into (functional) designs.

Quality Function Deployment (QFD) processes, devices, and methods match (functional) user needs to (functional) designs.

QFD processes, devices, and methods use (functional) user need surveys to transform (functional) user concepts into (functional) user needs, use (functional) sample design surveys and (functional) sample designs to transform (functional) sample designs into (functional) designs, and use (functional) dot-products to match (functional) user needs to (functional) designs.

KE-QT1, KE, CA, and QFD processes, devices, and methods thereby match user needs to designs, increase matching accuracy, and increase product quality, customer satisfaction, and product success.

KE-QT1, KE, CA, and QFD processes, devices, and methods however only increase matching accuracy for created designs, selected designs, and configured designs to (35.4) percent, (72.3) percent, and (68.1) percent.

| | | Created | | |
|---|---|---|---|---|
| Results | Methods | designs | Selected designs | Configured designs |
| (1) | KE-QT1 | 35.4 | 72.3 | 33.1 |
| (2) | KE | — | — | 68.1 |
| (3) | CA | — | — | 68.1 |
| (4) | QFD | 13.6 | 72.1 | 23.9 |

### SUMMARY

Latent Semantic Engineering (LSE) processes, devices, and methods match (aspirational, emotional, functional, physical) LSE semantic space user needs to (aspirational, emotional, functional, physical) LSE semantic space designs.

LSE processes, devices, and methods use (aspirational, emotional, functional, physical) user need descriptions to transform (aspirational, emotional, functional, physical) user concepts into (aspirational, emotional, functional, physical) user needs, use (aspirational, emotional, functional, physical) design descriptions to transform (aspirational, emotional, functional, physical) design concepts into (aspirational, emotional, functional, physical) designs, use (aspirational, emotional, functional, physical) singular value decompositions to transform (aspirational, emotional, functional, physical) designs into (aspirational, emotional, functional, physical) LSE semantic spaces, use (aspirational, emotional, functional, physical) LSE semantic space projections to transform (aspirational, emotional, functional, physical) user needs into (aspirational, emotional, functional, physical) LSE semantic space user needs, use (aspirational, emotional, functional, physical) LSE semantic space projections to transform (aspirational, emotional, functional, physical) designs into (aspirational, emotional, functional, physical) LSE semantic space designs, and use (aspirational, emotional, functional, physical) LSE semantic space cosines to match (aspirational, emotional, functional, physical) LSE semantic space user needs to (aspirational, emotional, functional, physical) LSE semantic space designs.

LSE processes, devices, and methods thereby match user needs to designs, increase matching accuracy, and increase product quality, customer satisfaction, and product success.

LSE processes, devices, and methods thereby increase matching accuracy for created designs, selected designs, and configured designs to (87.8) percent, (96.4) percent, and (87.4) percent.

| | | Created | | |
|---|---|---|---|---|
| Results | Methods | designs | Selected designs | Configured designs |
| (1) | LSE | 87.8 | 96.4 | 87.4 |
| (2) | KE-QT1 | 35.4 | 72.3 | 33.1 |
| (3) | KE | — | — | 68.1 |
| (4) | CA | — | — | 68.1 |
| (5) | QFD | 13.6 | 72.1 | 23.9 |
| (1-2) | p-value | 0.000 | 0.000 | 0.000 |

### DRAWINGS

FIG. 1 is a process, device, and method of the present invention.

FIG. 2A is a user need description of the present invention.

FIG. 2B is a design description of the present invention.

FIG. 2C is a user need of the present invention.

FIG. 2D is a design of the present invention.

FIG. 2E is a design matrix of the present invention

FIG. 2F is a design of the present invention.

FIG. 2G is a LSE semantic space design element matrix of the present invention.

FIG. 2H is a LSE semantic space scaling factor matrix of the present invention.

FIG. 2I is a LSE semantic space design matrix of the present invention.

FIG. 2J is a LSE semantic space user need of the present invention.

FIG. 2K is a LSE semantic space design of the present invention.

FIG. 2L is a created design of the present invention.

FIG. 2M is a selected design of the present invention.

FIG. 2N is a configured design of the present invention.

### EXEMPLARY EMBODIMENTS

Exemplary embodiments of the present invention are Latent Semantic Engineering methods, processes, and devices.

Latent Semantic Engineering (LSE) methods, processes, and devices 100 match (aspirational, emotional, functional, physical) LSE semantic space user needs to (aspirational, emotional, functional, physical) LSE semantic space designs.

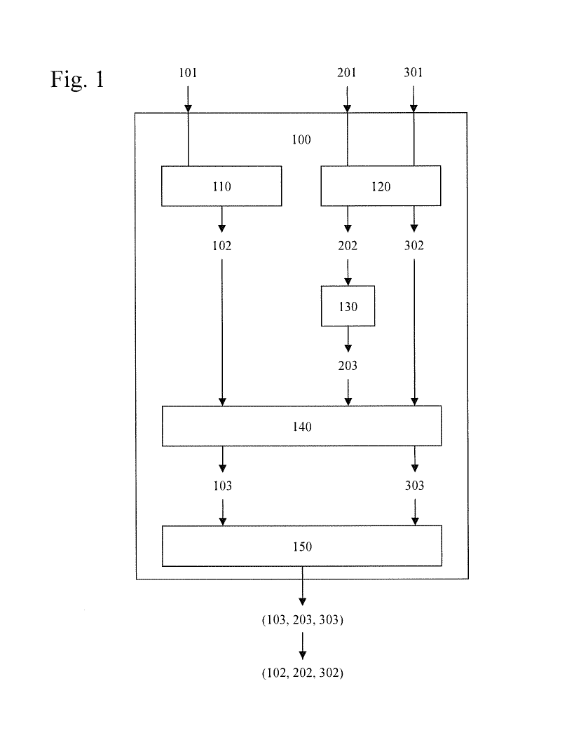

LSE processes, devices, and methods 100 (FIG. 1) use (aspirational, emotional, functional, physical) user need descriptions 110 to transform (aspirational, emotional, functional, physical) user concepts 101 into (aspirational, emotional, functional, physical) user needs 102, use (aspirational, emotional, functional, physical) design descriptions 120 to transform (aspirational, emotional, functional, physical) design concepts (201, 301) into (aspirational, emotional, functional, physical) designs (202, 302) use (aspirational, emotional, functional, physical) singular value decompositions 130 to transform (aspirational, emotional, functional, physical) designs 202 into (aspirational, emotional, functional, physical) LSE semantic spaces 203, use (aspirational, emotional, functional, physical) LSE semantic space projections 140 to transform (aspirational, emotional, functional, physical) user needs 102 into (aspirational, emotional, functional, physical) LSE semantic space user needs 103, use (aspirational, emotional, functional, physical) LSE semantic space projections 140 to transform (aspirational, emotional, functional, physical) designs 302 into (aspirational, emotional, functional, physical) LSE semantic space designs 303, and use (aspirational, emotional, functional, physical) LSE semantic space cosines 150 to match (aspirational, emotional, functional, physical) LSE semantic space user needs 103 to (aspirational, emotional, functional, physical) LSE semantic space designs (203, 303).

LSE processes, devices, and methods 100 (FIG. 1) thereby match user needs 102 to designs (202, 302), increase matching accuracy, and increase product quality, customer satisfaction, and product success.

LSE processes, devices, and methods 100 (FIG. 1) thereby increase matching accuracy for created designs (102, 202, 302), selected designs (102, 202, 302), and configured designs (102, 202, 302) to (87.8) percent, (96.4) percent, and (87.4) percent.

| | | Created | | |
|---|---|---|---|---|
| Results | Methods | designs | Selected designs | Configured designs |
| (1) | LSE | 87.8 | 96.4 | 87.4 |
| (2) | KE-QT1 | 35.4 | 72.3 | 33.1 |
| (3) | KE | — | — | 68.1 |
| (4) | CA | — | — | 68.1 |
| (5) | QFD | 13.6 | 72.1 | 23.9 |
| (1-2) | p-value | 0.000 | 0.000 | 0.000 |

### User Need Descriptions

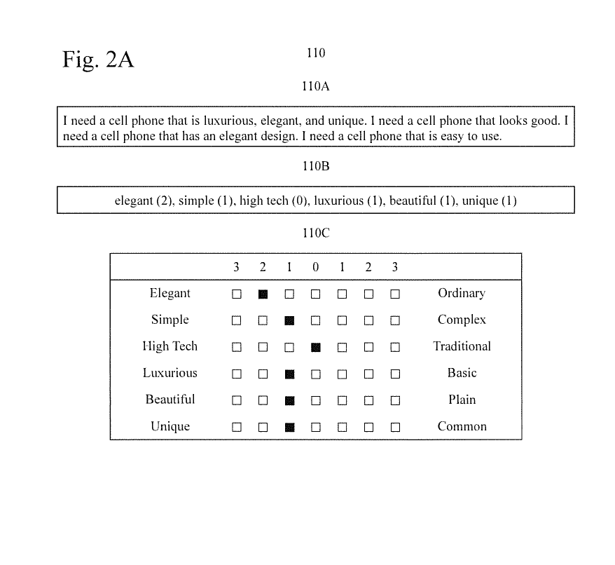

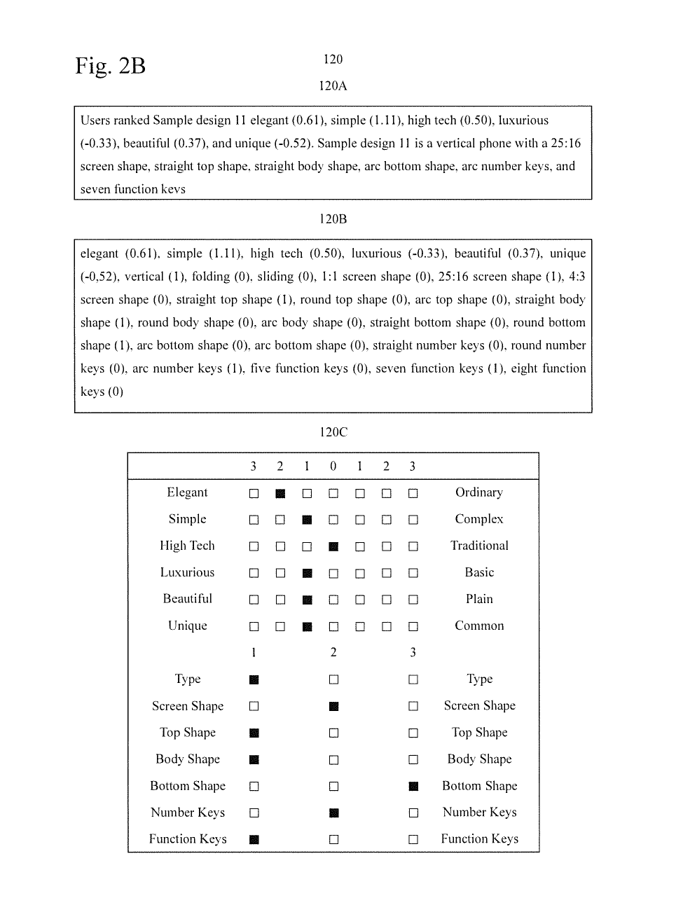

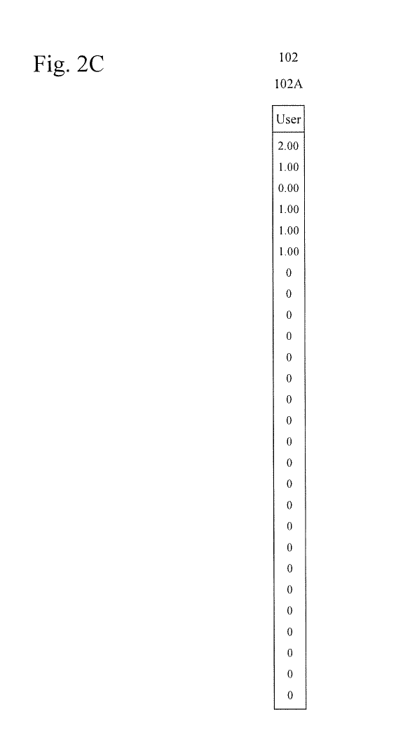

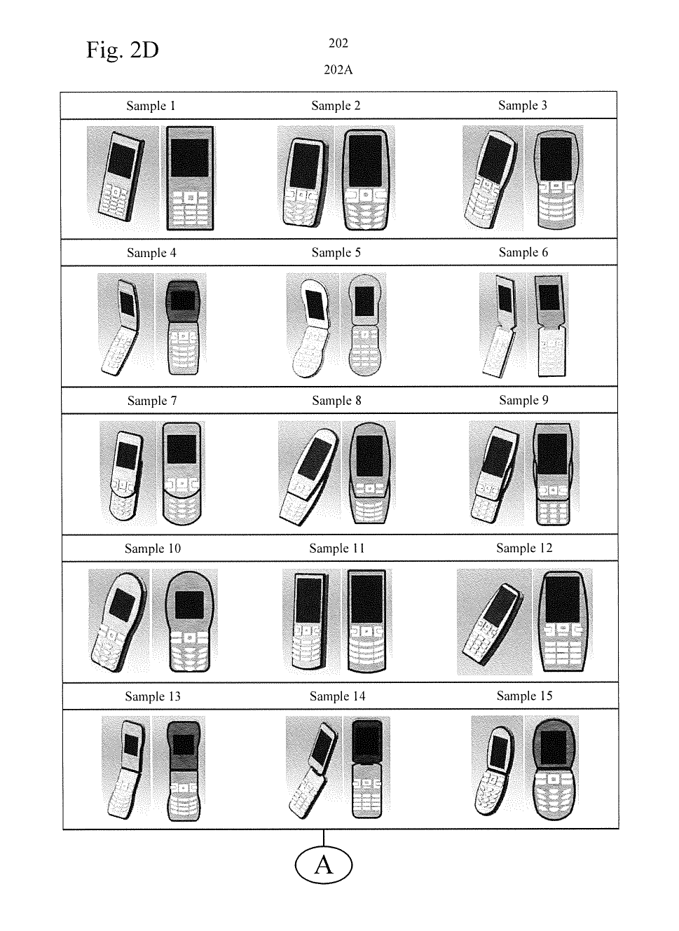

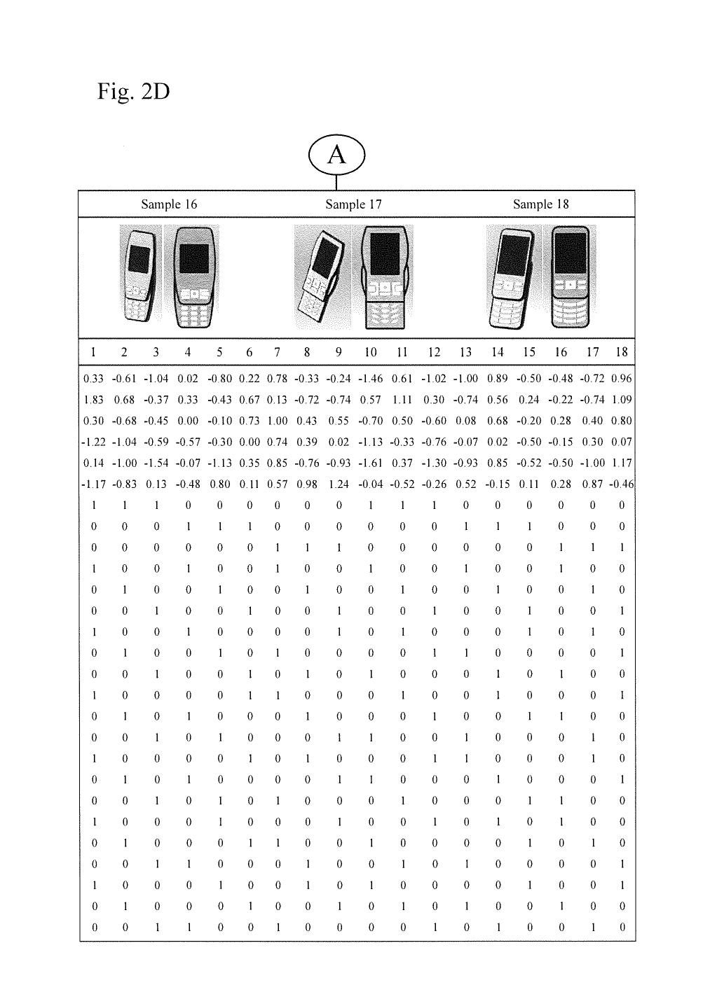

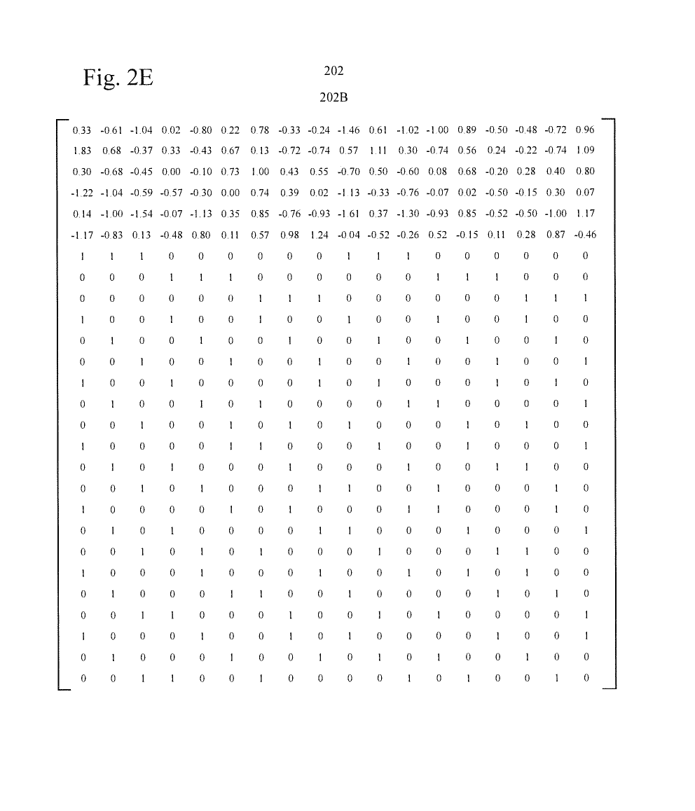

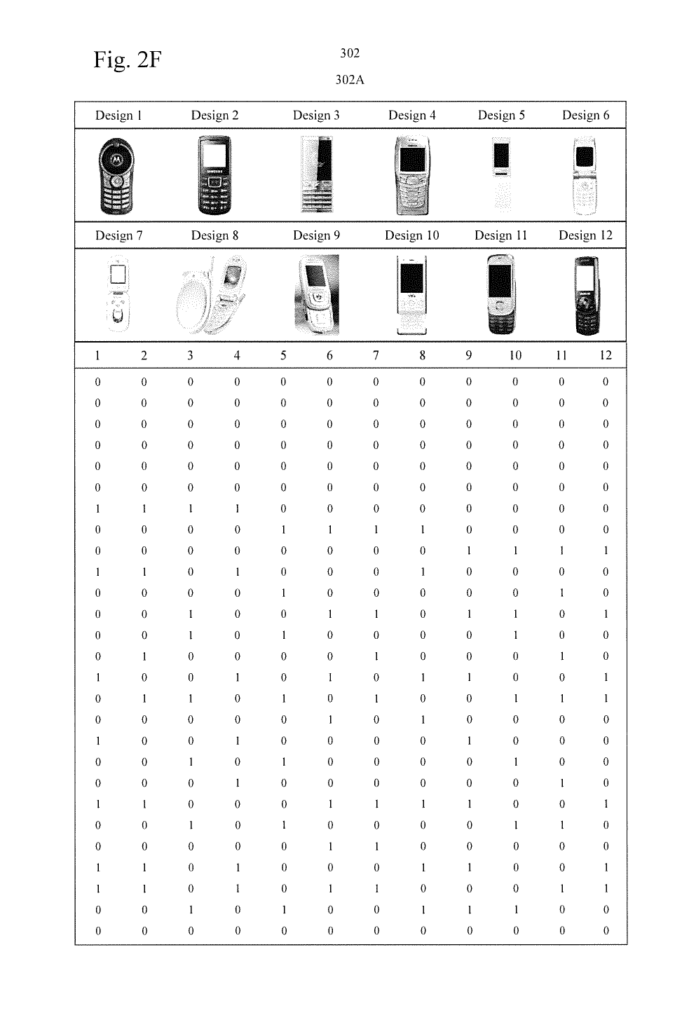

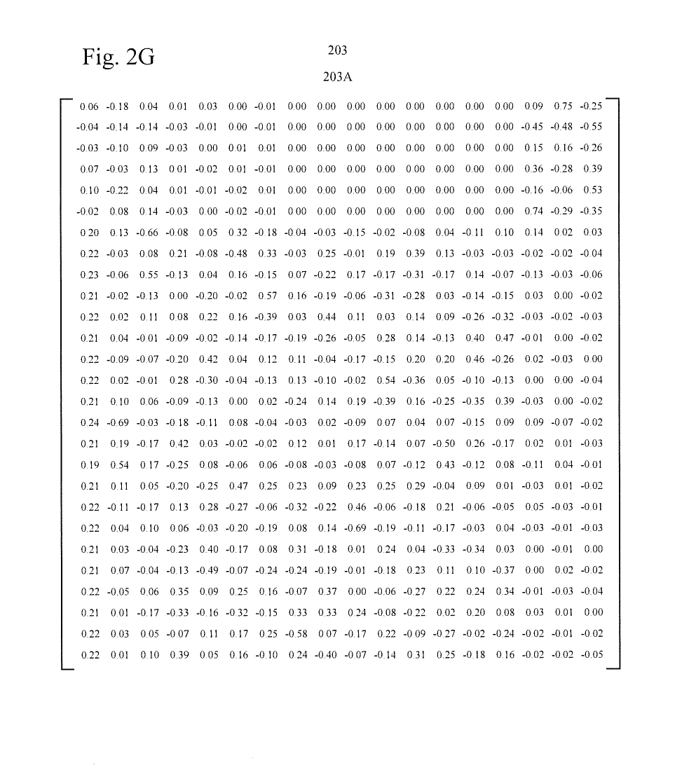

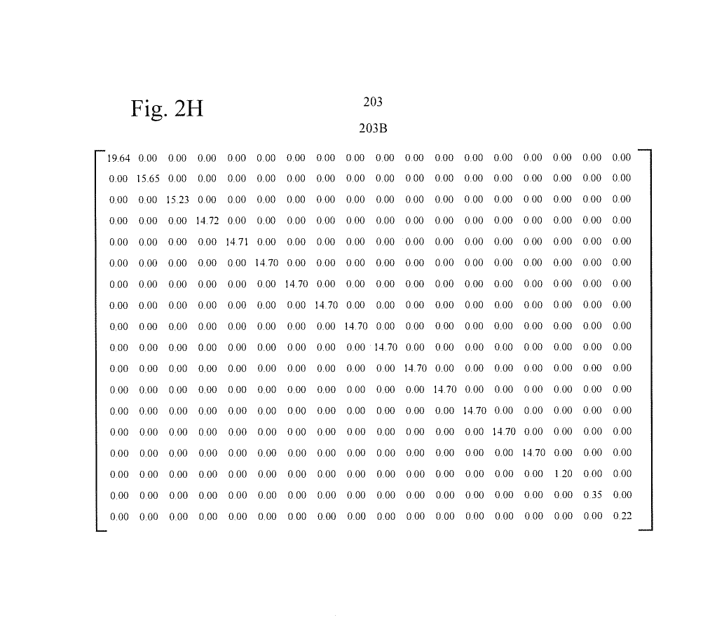

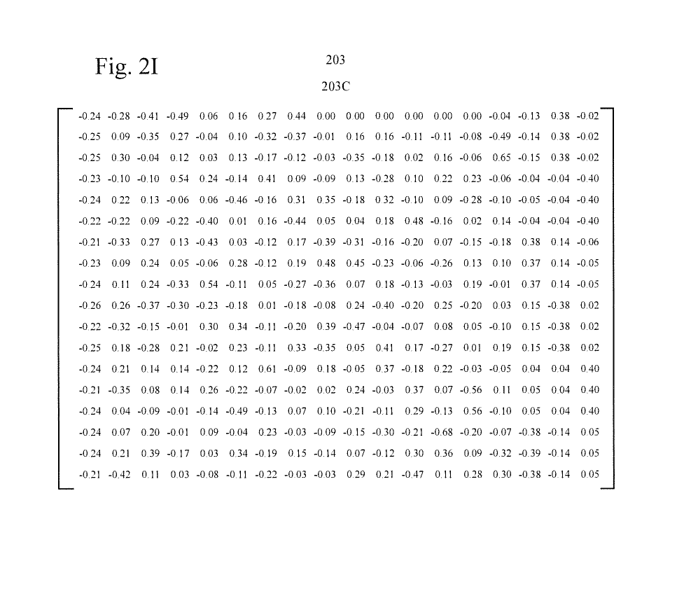

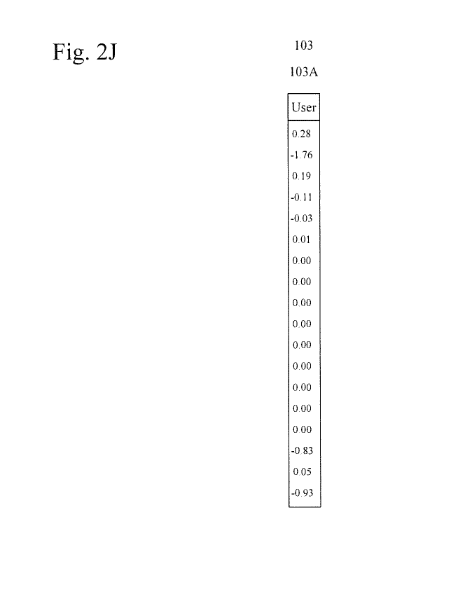

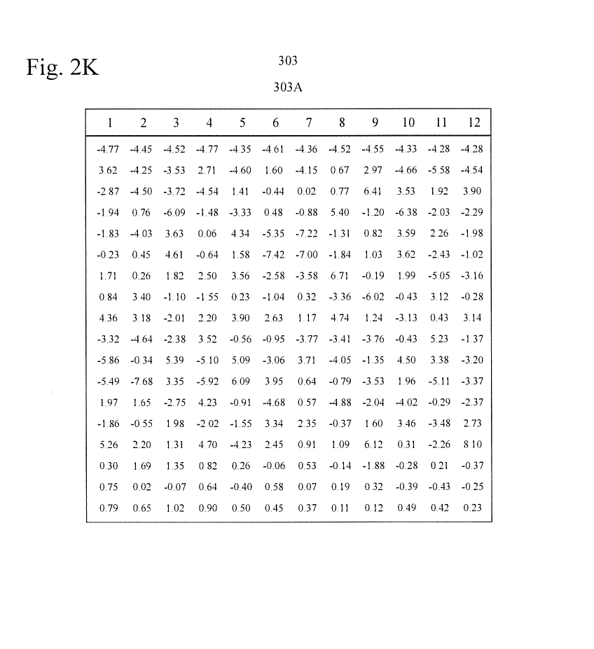

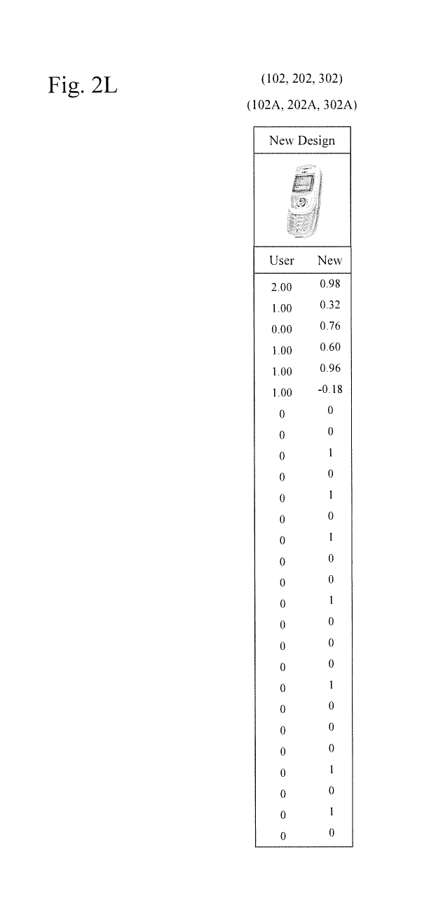

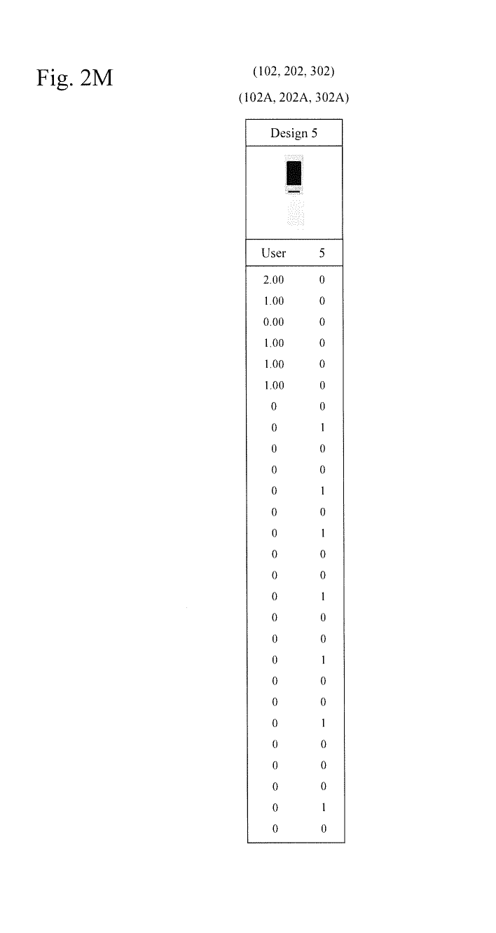

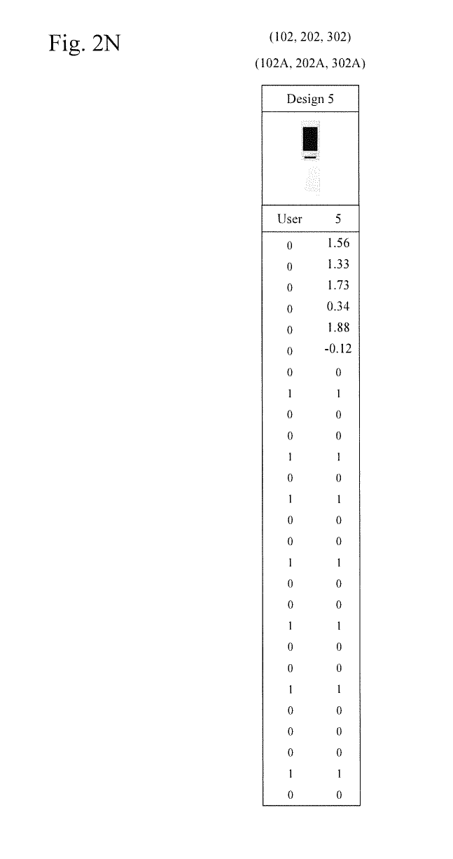

Exemplary embodiments of user need descriptions 110 (FIG. 1) are user need descriptions 110A, user need keywords 110B, or user need surveys 110C (FIG. 2A).

User need descriptions 110A are written by users, user need descriptions 110A contain any number of words, user need descriptions 110A contain (aspirational, emotional, functional, physical) words, user need descriptions 110A contain (technical, non-technical) words, user need descriptions 110A contain words that users select.

User need keywords 110B are derived from user need descriptions, user need keywords 110B contain any number of keywords, user need keywords 110B contain (aspirational, emotional, functional, physical) keywords, user need keywords 110B contain (technical, non-technical) keywords, user need keywords 110B contain keywords that users select.

User need surveys 110C are completed by users, user need surveys 110C contain any number of user needs, user need surveys 110C contain (aspirational, emotional, functional, physical) user needs, user need surveys 110C contain (technical, non-technical) user needs, user need surveys 110C contain user needs that users select.

### Design Descriptions

Exemplary embodiments of design descriptions 120 (FIG. 1) are design descriptions 120A, design keywords 120B, or design surveys 120C (FIG. 2B).

Design descriptions 120A (FIG. 2B) are written by designers, design descriptions 120A contain any number of words, design descriptions 120A contain (aspirational, emotional, functional, physical) words, design descriptions 120A contain (technical, non-technical) words, design descriptions 120A contain words that designers select.

Design keywords 120B (FIG. 2B) are derived from design descriptions, design keywords 120B contain any number of keywords, design keywords 120B contain (aspirational, emotional, functional, physical) keywords, design keywords 120B contain (technical, non-technical) keywords, design keywords 120B contain keywords that designers select.

Design surveys 120C (FIG. 2B) are completed by designers, design surveys 120C contain any number of design elements, design surveys 120C contain (technical, non-technical) design elements, design surveys 120C contain design elements that designers select.

### User Needs

Exemplary embodiments of user needs 102 (FIG. 1) are user need vectors 102A (FIG. 2C).

User need vectors 102A (FIG. 2C) are derived from user need descriptions, user need vectors 102A contain any number of user needs, user need vectors 102A contain (aspirational, emotional, functional, physical) user needs, user need vectors 102A contain (technical, non-technical) user needs, user need vectors 102A contain user needs that users select.

### Designs

Exemplary embodiments of designs (202, 302) (FIG. 1) are design vectors 202A (FIG. 2D), design matrices 202B (FIG. 2E), and design vectors 302A (FIG. 2F).

Design vectors 202A (FIG. 2D) are derived from design descriptions, design vectors 202A contain any number of design elements, design vectors 202A contain (aspirational, emotional, functional, physical) design elements, design vectors 202A contain (technical, non-technical) design elements, design vectors 202A contain design elements that designers select.

Design matrices 202B (FIG. 2E) are derived from design vectors, design matrices 202B contain any number of design vectors 202A, design vectors 202A contain any number of design elements, design vectors 202A contain (aspirational, emotional, functional, physical) design elements, design vectors 202A contain (technical, non-technical) design elements, design vectors 202A contain design elements that designers select.

Design vectors 302A (FIG. 2F) are derived from design descriptions, design vectors 302A contain any number of design elements, design vectors 302A contain (aspirational, emotional, functional, physical) design elements, design vectors 302A contain (technical, non-technical) design elements, design vectors 302A contain design elements that designers select.

### LSE Semantic Spaces

Exemplary embodiments of LSE semantic spaces 203 (FIG. 1) are singular value decompositions 130 of design matrices 202.

Singular value decompositions 130 of design matrices 202 (FIG. 1) are LSE semantic space design element matrices 203A (FIG. 2G), LSE semantic space scaling factor matrices 203B (FIG. 2H), and LSE semantic space design matrices 203C (FIG. 2I).

LSE semantic space design element matrices 203A (FIG. 2G) contain any number of LSE semantic space design element vectors, LSE semantic space design element vectors contain any number of LSE semantic space design elements, LSE semantic space design element vectors contain (aspirational, emotional, functional, physical) LSE semantic space design elements, LSE semantic space design element vectors contain (technical, non-technical) LSE semantic space design elements, and LSE semantic space design element vectors contain LSE semantic space design elements that designers select.

LSE semantic space scaling factor matrices 203B (FIG. 2H) contain any number of LSE semantic space scaling factor vectors, LSE semantic space scaling factor vectors contain one scaling factor.

LSE semantic space design matrices 203C (FIG. 2I) contain any number of LSE semantic space design vectors, LSE semantic space design vectors contain any number of LSE semantic space design elements, LSE semantic space design matrices contain (aspirational, emotional, functional, physical) LSE semantic space design elements, LSE semantic space design vectors contain (technical, non-technical) LSE semantic space design elements, and LSE semantic space design vectors contain LSE semantic space design elements that designers select.

### LSE Semantic Space User Needs

Exemplary embodiments of LSE semantic space user needs 103 (FIG. 1) are LSE semantic space projections 140 of user needs 102.

LSE semantic space projections 140 of user needs 102 (FIG. 1) are user need vector 102A (FIG. 2C), LSE semantic space design element matrix 203A (FIG. 2G) products, user need vector 102A (FIG. 2C), LSE semantic space design element matrix 203A (FIG. 2G) products are LSE semantic space user need vectors 103A (FIG. 2J), LSE semantic space user need vectors 103A contain any number of LSE semantic space user needs, LSE semantic space user need vectors 103A contain (aspirational, emotional, functional, physical) LSE semantic space user needs, LSE semantic space user need vectors 103A contain (technical, non-technical) LSE semantic space user needs, and LSE semantic space user need vectors 103A contain LSE semantic space user needs that users select.

### LSE Semantic Space Designs

Exemplary embodiments of LSE semantic space designs 303 (FIG. 1) are LSE semantic space projections 140 of designs 302.

LSE semantic space projections 140 of designs 302 (FIG. 1) are design vector 302A (FIG. 2F), LSE semantic space design element matrix 203A (FIG. 2G) products, design vector 302A (FIG. 2F), LSE semantic space design element matrix 203A (FIG. 2G) products are LSE semantic space design vectors 303A (FIG. 2K), LSE semantic space design vectors 303A contain any number of LSE semantic space design elements, LSE semantic space design vectors 303A contain (aspirational, emotional, functional, physical) LSE semantic space design elements, LSE semantic space design vectors 303A contain (technical, non-technical) LSE semantic space design elements, and LSE semantic space design vectors 303A contain LSE semantic space design elements that designers select.

### Created Designs

Exemplary embodiments of created designs (102, 202, 302) (FIG. 1) are designs with LSE semantic space design elements 203A (FIG. 2G) that match LSE semantic space user needs 103A (FIG. 2J).

LSE semantic space design elements 203A (FIG. 2G) that match LSE semantic space user needs 103A (FIG. 2J) are LSE semantic space design elements with maximum LSE semantic space cosines (102A, 202A, 302A) (FIG. 2L).

### Selected Designs

Exemplary embodiments of selected designs (102, 202, 302) (FIG. 1) are designs with LSE semantic space designs 303A (FIG. 2K) that match LSE semantic space user needs 103A (FIG. 2J).

LSE semantic space designs 303A (FIG. 2K) that match LSE semantic space user needs 103A (FIG. 2J) are LSE semantic space designs with maximum LSE semantic space cosines (102A, 202A, 302A) (FIG. 2M).

### Configured Designs

Exemplary embodiments of configured designs (102, 202, 302) (FIG. 1) are designs with LSE semantic space design elements 203A (FIG. 2G) that match LSE semantic space user choices 303A (FIG. 2K).

LSE semantic space design elements 203A (FIG. 2G) that match LSE semantic space user choices 303A (FIG. 2K) are LSE semantic space design elements with maximum LSE semantic space cosines (102A, 202A, 302A) (FIG. 2N).

### Exemplary Applications

Exemplary applications of the present invention are computer-aided design systems, design configuration systems, and online ordering systems wherein, LSE processes, devices, and methods use (aspirational, emotional, functional, physical) user need descriptions to transform (aspirational, emotional, functional, physical) user concepts into (aspirational, emotional, functional, physical) user needs, use (aspirational, emotional, functional, physical) design descriptions to transform (aspirational, emotional, functional, physical) design concepts into (aspirational, emotional, functional, physical) designs, use (aspirational, emotional, functional, physical) singular value decompositions to transform (aspirational, emotional, functional, physical) designs into (aspirational, emotional, functional, physical) LSE semantic spaces, use (aspirational, emotional, functional, physical) LSE semantic space projections to transform (aspirational, emotional, functional, physical) user needs into (aspirational, emotional, functional, physical) LSE semantic space user needs, use (aspirational, emotional, functional, physical) LSE semantic space projections to transform (aspirational, emotional, functional, physical) designs into (aspirational, emotional, functional, physical) LSE semantic space designs, and use (aspirational, emotional, functional, physical) LSE semantic space cosines to match (aspirational, emotional, functional, physical) LSE semantic space user needs to (aspirational, emotional, functional, physical) LSE semantic space designs.

Exemplary applications of the present invention are computer-aided design systems, design configuration systems, and online ordering systems wherein, LSE processes, devices, and methods thereby match user needs to designs, increase matching accuracy, and increase product quality, customer satisfaction, and product success.

Exemplary applications of the present invention therefore are computer programs that run on computer systems. Exemplary applications of the present invention therefore however are not limited thereto.

What is claimed is:

1. Latent Semantic Engineering processes, devices, and methods, comprising:
user need descriptions;
wherein, user need descriptions are user need descriptions, user need keywords, or user need surveys;
wherein, user need descriptions are written by users, user need descriptions contain any number of words, user need descriptions contain (aspirational, emotional, functional, physical) words, user need descriptions contain (technical, non-technical) words, user need descriptions contain words that users select;
wherein, user need keywords are derived from user need descriptions, user need keywords contain any number of keywords, user need keywords contain (aspirational, emotional, functional, physical) keywords, user need keywords contain (technical, non-technical) keywords, user need keywords contain keywords that users select;
wherein, user need surveys are completed by users, user need surveys contain any number of user needs, user need surveys contain (aspirational, emotional, functional, physical) user needs, user need surveys contain (technical, non-technical) user needs, user need surveys contain user needs that users select.

2. Latent Semantic Engineering processes, devices, and methods, comprising:
design descriptions;
wherein, design descriptions are design descriptions, design keywords, or design surveys;
wherein, design descriptions are written by designers, design descriptions contain any number of words, design descriptions contain (aspirational, emotional, functional, physical) words design descriptions contain (technical, non-technical) words, design descriptions contain words that designers select;
wherein, design keywords are derived from design descriptions, design keywords contain any number of keywords, design keywords contain (aspirational, emotional, functional, physical) keywords, design keywords contain (technical, non-technical) keywords, design keywords contain keywords that designers select;
wherein, design surveys are completed by designers, design surveys contain any number of design elements, design surveys contain (technical, non-technical) design elements, design surveys contain design elements that designers select.

3. Latent Semantic Engineering processes, devices, and methods, comprising:
user needs;
wherein, user needs are user need vectors;
wherein, user need vectors are derived from user need descriptions, user need vectors contain any number of user needs, user need vectors contain (aspirational, emotional, functional, physical) user needs, user need vectors contain (technical, non-technical) user needs, user need vectors contain user needs that users select.

4. Latent Semantic Engineering processes, devices, and methods, comprising:
designs;
wherein, designs are design vectors and design matrices;
wherein, design vectors are derived from design descriptions, design vectors contain any number of design elements, design vectors contain (aspirational, emotional, functional, physical) design elements, design vectors contain (technical, non-technical) design elements, design vectors contain design elements that designers select;
wherein, design matrices are derived from design vectors, design matrices contain any number of design vectors, design vectors contain any number of design elements, design vectors contain (aspirational, emotional, functional, physical) design elements, design vectors contain (technical, non-technical) design elements, design vectors contain design elements that designers select.

5. Latent Semantic Engineering processes, devices, and methods, comprising:
Latent Semantic Engineering semantic spaces;
wherein, Latent Semantic Engineering semantic spaces are singular value decompositions of design matrices;
wherein, singular value decompositions of design matrices are Latent Semantic Engineering semantic space design element matrices, Latent Semantic Engineering semantic space scaling factor matrices, and Latent Semantic Engineering semantic space design matrices;
wherein, Latent Semantic Engineering semantic space design element matrices contain any number of Latent Semantic Engineering semantic space design element vectors, design element vectors contain any number of Latent Semantic Engineering semantic space design elements, Latent Semantic Engineering semantic space design element vectors contain (aspirational, emotional, functional, physical) Latent Semantic Engineering semantic space design elements, Latent Semantic Engineering semantic space design element vectors contain (technical, non-technical) Latent Semantic Engineering semantic space design elements, and Latent Semantic Engineering semantic space design element vectors contain Latent Semantic Engineering semantic space design elements that designers select;
wherein, Latent Semantic Engineering semantic space scaling factor matrices contain Latent Semantic Engineering semantic space scaling factor vectors, semantic space scaling factor vectors contain one scaling factor;
wherein, Latent Semantic Engineering semantic space design matrices contain any number of Latent Semantic Engineering semantic space design vectors, Latent Semantic Engineering semantic space design vectors contain any number of Latent Semantic Engineering semantic space design elements, Latent Semantic Engineering semantic space design vectors contain (aspirational, emotional, functional, physical) Latent Semantic Engineering semantic space design elements, Latent Semantic Engineering semantic space design vectors contain (technical, non-technical) Latent Semantic Engineering semantic space design elements, and Latent Semantic Engineering semantic space design vectors contain LSE semantic space design elements that designers select.

6. Latent Semantic Engineering processes, devices, and methods, comprising:
Latent Semantic Engineering semantic space user needs;
wherein, Latent Semantic Engineering semantic space user needs are Latent Semantic Engineering semantic space projections of user needs;
wherein, Latent Semantic Engineering semantic space projections of user needs are user need vector, Latent Semantic Engineering semantic space design element matrix products, Latent Semantic Engineering semantic space projections of user needs are user need vector, Latent Semantic Engineering semantic space design element matrix products are Latent Semantic Engineering semantic space user need vectors, Latent Semantic Engineering semantic space user need vectors contain any number of Latent Semantic Engineering semantic space user needs, Latent Semantic Engineering semantic space user need vectors contain (aspirational, emotional, functional, physical) Latent Semantic Engineering semantic space user needs, Latent Semantic Engineering semantic space user need vectors contain (technical, non-technical) Latent Semantic Engineering semantic space user needs, Latent Semantic Engineering semantic space user need vectors contain Latent Semantic Engineering semantic space user needs that users select.

7. Latent Semantic Engineering processes, devices, and methods, comprising:
Latent Semantic Engineering semantic space designs;
wherein, Latent Semantic Engineering semantic space designs are Latent Semantic Engineering semantic space projections of designs;
wherein, Latent Semantic Engineering semantic space projections of designs are design vector, Latent Semantic Engineering semantic space design element matrix products, design vector, Latent Semantic Engineering semantic space design element matrix products are Latent Semantic Engineering semantic space design vectors, Latent Semantic Engineering semantic space design vectors contain any number of Latent Semantic Engineering semantic space design elements, Latent Semantic Engineering semantic space design vectors designs contain (aspirational, emotional, functional, physical) Latent Semantic Engineering semantic space design elements, Latent Semantic Engineering semantic space design vectors contain (technical, non-technical) Latent Semantic Engineering semantic space design elements, and Latent Semantic Engineering semantic space design vectors contain Latent Semantic Engineering semantic space design elements that designers select.

8. Latent Semantic Engineering processes, devices, and methods, comprising:
created designs;
wherein, created designs are designs with Latent Semantic Engineering semantic space design elements that match Latent Semantic Engineering semantic space user needs;
wherein, Latent Semantic Engineering semantic space design elements that match Latent Semantic Engineering semantic space user needs are Latent Semantic Engineering semantic space design elements with maximum Latent Semantic Engineering semantic space cosines.

9. Latent Semantic Engineering processes, devices, and methods, comprising:
selected designs;
wherein, selected designs are designs with Latent Semantic Engineering semantic space designs that match Latent Semantic Engineering semantic space user needs;
wherein, Latent Semantic Engineering semantic space designs that match Latent Semantic Engineering semantic space user needs are Latent Semantic Engineering semantic space designs with maximum Latent Semantic Engineering semantic space cosines.

10. Latent Semantic Engineering processes, devices, and methods, comprising:
configured designs;
wherein, configured designs are designs with Latent Semantic Engineering semantic space design elements that match Latent Semantic Engineering semantic space user choices;
wherein, Latent Semantic Engineering semantic space design elements that match Latent Semantic Engineering semantic space user choices are Latent Semantic Engineering semantic space design elements with maximum Latent Semantic Engineering semantic space cosines.

11. Latent Semantic Engineering applications, comprising:
computer-aided design systems, design configuration systems, and online ordering systems;
wherein, Latent Semantic Engineering processes, devices, and methods use (aspirational, emotional, functional, physical) user need descriptions to transform (aspirational, emotional, functional, physical) user concepts into (aspirational, emotional, functional, physical) user needs, use (aspirational, emotional, functional, physical) design descriptions to transform (aspirational, emotional, functional, physical) design concepts into (aspirational, emotional, functional, physical) designs, use (aspirational, emotional, functional, physical) singular value decompositions to transform (aspirational, emotional, functional, physical) designs into (aspirational, emotional, functional, physical) Latent Semantic Engineering semantic spaces, use (aspirational, emotional, functional, physical) Latent Semantic Engineering semantic space projections to transform (aspirational, emotional, functional, physical) user needs into (aspirational, emotional, functional, physical) Latent Semantic Engineering semantic space user needs, use (aspirational, emotional, functional, physical) Latent Semantic Engineering semantic space projections to transform (aspirational, emotional, functional, physical) designs into (aspirational, emotional, functional, physical) Latent Semantic Engineering semantic space designs, and use (aspirational, emotional, functional, physical) Latent Semantic Engineering semantic space cosines to match (aspirational, emotional, functional, physical) Latent Semantic Engineering semantic space user needs to (aspirational, emotional, functional, physical) Latent Semantic Engineering semantic space designs;
wherein, LSE processes, devices, and methods thereby match user needs to designs, increase matching accuracy, and increase product quality, customer satisfaction, and product success.
